(19) United States
(12) Patent Application Publication
(10) Pub. No.: US 2019/0197609 A1
(43) Pub. Date: Jun. 27, 2019

(54) SIMULATING CONTENT ITEM SELECTION EVENTS IN A COMPUTER SYSTEM

(71) Applicant: Microsoft Technology Licensing, LLC, Redmond, WA (US)

(72) Inventors: Steve Na, Mountain View, CA (US); Anuj Malhotra, Union City, CA (US); Jingjing Huang, Sunnyvale, CA (US)

(21) Appl. No.: 15/853,414

(22) Filed: Dec. 22, 2017

(51) Int. Cl. G06Q 30/08; G06F 7/02; G06Q 30/06

(52) U.S. Cl. CPC G06Q 30/08; G06Q 30/0643; G06F 7/02

(57) ABSTRACT

Techniques for simulating content item selection events (CISEs) in a computer system are provided. For a first CISE, a first amount that a first content provider contributed as a result of being selected for the first CISE is determined. The first CISE is simulated by determining a second amount that a second content provider would have contributed as a result of the first CISE if the second content provider was selected for the first CISE instead of the first content provider. A second CISE is simulated in order to determine a difference between a third amount that a third content provider contributed as a result of being selected for the second CISE and a fourth amount that the third content provider would have contributed if the first content provider was not a candidate for selection in the second CISE. Based on the three amounts, an incremental value ratio for the first content provider is calculated.

### TECHNICAL FIELD

The present disclosure relates to simulating online events and, more particularly, to determining a contribution level of different content item providers to electronic content transmission. SUGGESTED CLASSIFICATION: 703/4; SUGGESTED ART UNIT: 2123.

### BACKGROUND

A goal of many providers of online content is to provide high quality and highly relevant content to many users to induce users to perform some action, such as viewing online video, sharing content with connections in a social network, etc. In some online scenarios, multiple content providers are competing for the same online real estate in which to display their respective digital content. Such a competition is referred to herein as a “content item selection event” where multiple content items are considered for transmitting over a computer network in response to a content request and only a strict subset of the considered content items are selected.

Many factors may go into determining which content item(s) to select during a content item selection event. Factors may include objective measures of quality of the content items, past performance of the content items, and attributes of the computing device that initiated the content request. Results of each content item selection event may be analyzed to determine the relevant performance of different content providers. However, relying on those results alone does not reflect the true value of each content provider that participates in the content item selection events. Current approaches for determining the relative value of different content providers are naïve and have led to the misallocation of valuable resources, including computer resources and manual labor.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram that depicts an event simulator, in an embodiment;

FIG. 3 is a flow diagram that depicts an example process for simulating content item selection events, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for simulating content item selection events in a computer system are provided. In one approach, multiple content item selection events in which a content item of a particular content provider was a candidate for selection are identified. Those content item selection events are effectively rerun except without the content item from the particular content provider. A computation of an amount of what other content provider(s) of each selected content item would contribute is used to determine how valuable the particular content provider is to a content delivery exchange that conducted the original content item selection events.

### System Overview

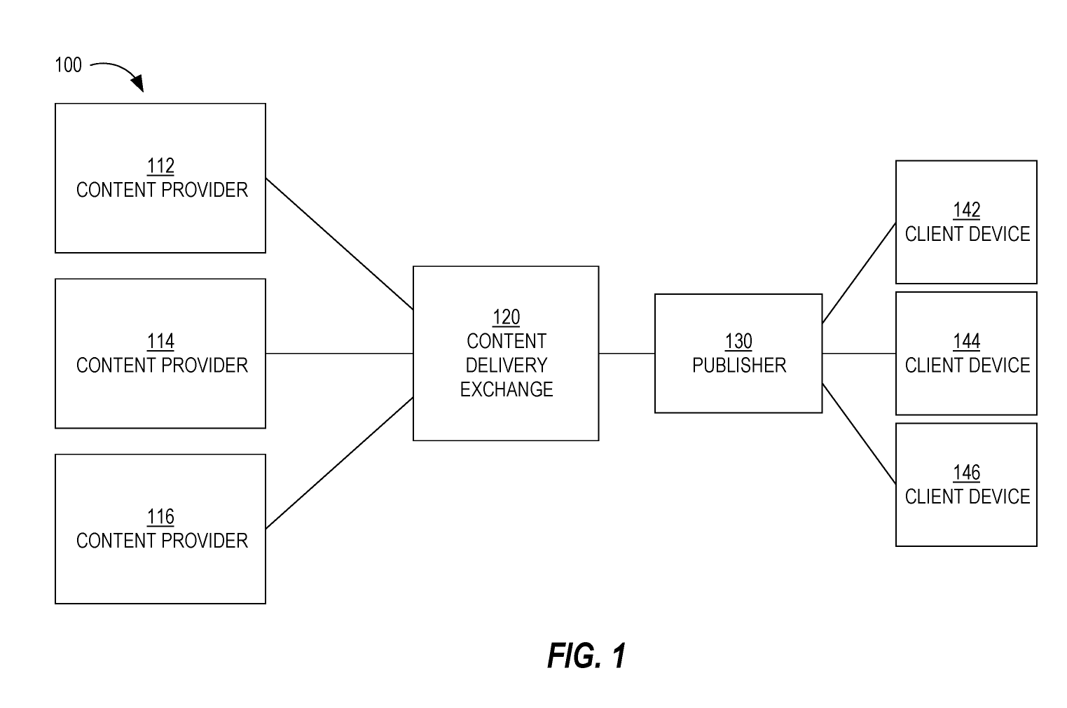

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, through publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Although depicted in a single element, content delivery exchange 120 may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 120 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a resource budget that indicates how much the corresponding content provider is willing to be charged by content delivery exchange 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 120 receives triggers a content item selection event.

For example, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 120 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event, information such as the minimum winning bid or the highest bid of the content item that was not selected during the content item selection event.

### Tracking User Interactions

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item.

### Content Provider Value

Some content providers have a large impact in a content delivery exchange. “Impact” may be measured in a number of ways, such as the number of content item selection events in which content items of a content provider are candidates, an amount the content provider compensates the content delivery exchange for selecting content items provided by the content provider, an amount the content provider compensates the content delivery exchange for users selecting content items that the content delivery exchange has selected for presentation to those users. One approach for measuring impact of a content provider is to total the amount of compensation that the content provider has provided to content delivery exchange 120. However, such a straightforward metric does not really reflect the content provider's impact if there are other content providers who would have compensated content delivery exchange 120 the same or similar amount if content items of the other content providers were selected for presentation instead.

### Direct Amount

In an embodiment, a value for a content provider is calculated based on an amount that the content provider compensated content delivery exchange 120 for presenting content items provided by the content provider. This amount is referred to herein as a “direct amount.” For example, if content provider 112 provided one thousand units (which could be in dollars, euros, or other currency) to content delivery exchange 120 for selecting and presenting content items provided by content provider 112, then that amount is used to calculate a value for content provider 112.

A direct amount may be determined for a content provider on an individual content item selection event basis and/or a group (of content item selection events) basis. For example, a direct amount for a content provider may be calculated for all content item selection events that occurred within the last fourteen days.

Table A illustrates an example content item selection event where a user interface (displayed on a screen of a client device) includes multiple slots or positions where content items may be placed and presented. The slots may fit simultaneously on a screen of a client device. Alternatively, one or more of the slots may not be displayed until a user scrolls through the user interface. Such scrolling may be necessary to display all slots due to either the limited size of the screen of the client device and/or due to the number of slots in which content items will be displayed.

TABLE A

| | | | | Revenue | |
|---|---|---|---|---|---|
| Auction | Content | | Campaign | (predicted | |
| Position | Provider | Bid | Floor | eCPM) | Scroll |
| 1 | A | 20.00 | 10.00 | 15.00 | 1 |
| 2 | B | 15.00 | 10.00 | 12.00 | 1 |
| 3 | C | 12.00 | 12.00 | 12.00 | 1 |
| 4 | D | 10.00 | 9.50 | 9.50 | 1 |
| 5 | E | 9.00 | 2.00 | 8.50 | 1 |
| 6 | F | 8.50 | 2.00 | 0 | 0 |
| 7 | G | 8.25 | 2.00 | 0 | 0 |
| 8 | H | 8.20 | 2.00 | 0 | 0 |
| 9 | I | 8.15 | 2.00 | 0 | 0 |
| 10 | J | 8.00 | 2.00 | 0 | 0 |
| | | | Total | 57.00 | |

In this example scenario, if content provider A does not participate in this content item selection event, then the direct amount of content provider A is 15.00 units. If content provider B does not participate in this content item selection event, then the direct amount of content provider B is 12.00 units.

The values in revenue column are determined based on a second price model. Thus, a content provider compensates content delivery exchange 120 for the next highest bid price instead of the bid price of the content provider, subject to a campaign floor associated with the content provider's campaign, if one exists. Thus, while content provider A compensates content delivery exchange 120 15.00 units instead of 20.00 units (because the bid price from content provider B is 15.00), content provider C compensates content delivery exchange 120 12.00 units instead of 10.00 units, since 12.00 units is the campaign floor associated with content provider C's campaign. “eCPM” refers to an effective cost per thousand impressions. Even if a campaign is a CPC campaign or a CPA campaign, an eCPM can still be calculated for that campaign by multiplying the CPC/CPA value of that campaign by a predicted click-through rate (CTR) of that campaign.

In this example scenario, each content delivery campaign is associated with a campaign floor value. Embodiments are not so limited. For example, some content delivery campaigns may have respective campaign floor values while other content delivery campaigns may not have any campaign floor value. As another example, no content delivery campaign is associated with a campaign floor value.

In this example scenario, a content item selection event involves selecting multiple content items from different content delivery campaigns for presentation on a screen of a client device. However, embodiments are not so limited. For example, some content item selection events that content delivery exchange 120 conducts may involve selection multiple content items for selection (as in the example scenario) while other content item selection events involve only a single content item. As another example, content delivery exchange 120 only conducts content item selection events that involve selecting only a single content item for presentation.

### Replacement Amount

In an embodiment, a value is calculated for a particular content provider based on an amount that one or more other content providers would have compensated content delivery exchange 120 if the one or more other content providers would have participated in one or more content item selection events (instead of the particular content provider) in which a content item of the particular content provider was selected for presentation. In other words, in a content item selection event in which a content item of a particular content provider was selected, this amount is an amount that another content provider (whose content item was not selected) would have compensated content delivery exchange 120. This amount is referred to herein as a “replacement amount.” For example, if content provider 112 would not participate in a content item selection event (in which content provider 112 actually did participate) and content provider 114 (which did not participate in the content item selection event) would have participated instead, then the amount that content provider 114 would have compensated content delivery exchange 120 is used to calculate a value for content provider 112. For any particular content item selection event, the replacement amount is likely to be less than the direct amount, especially if the content item selection event involves selecting multiple content items for presentation.

Thus, a replacement amount may be determined for a content provider on an individual content item selection event basis and/or a group (of content item selection events) basis. For example, a replacement amount for a content provider may be calculated for all content item selection events that occurred within the last 24 hours.

Table B illustrates a simulated content item selection event that is based on the example content item selection event of Table A. In this simulated event, content provider A (or one of its content items) does not participate in the simulated content item selection event, but, as a result, content provider F (or one of its content items) would have participated:

TABLE B

| | | | | Revenue | |
|---|---|---|---|---|---|
| Auction | Content | | Campaign | (predicted | |
| Position | Provider | Bid | Floor | eCPM) | Scroll |
| 1 | A | | | | |
| 2 | B | 15.00 | 10.00 | 12.00 | 1 |
| 3 | C | 12.00 | 12.00 | 12.00 | 1 |
| 4 | D | 10.00 | 9.50 | 9.50 | 1 |
| 5 | E | 9.00 | 2.00 | 8.50 | 1 |
| 6 | F | 8.50 | 2.00 | 8.25 | 1 |
| 7 | G | 8.25 | 2.00 | 0 | 0 |
| 8 | H | 8.20 | 2.00 | 0 | 0 |
| 9 | I | 8.15 | 2.00 | 0 | 0 |
| 10 | J | 8.00 | 2.00 | 0 | 0 |
| | | | Total | 50.25 | |

In this simulated event, the direct amount of content provider A is 15.00 units and the replacement amount is 8.25 units. In other words, removing content provider A results in 15.00 units being lost. However, content provider F would have had an opportunity in this simulated event to have one of its content items selected for display; thus, there is a gain (or replacement amount) of 8.25 units. Therefore, the overall value for content provider A with respect to this content item selection event is 15.00−8.25=6.75 units. This “overall value” is referred to herein as an “incremental value.” An incremental value represents a difference between the direct amount and the replacement amount.

A ratio of (1) incremental value(s) to (2) the direct amount(s) may be calculated, which, for the above example simulated event, would be 6.75/15.00=45%. This ratio is referred to herein as an “incremental value ratio.” An incremental value ratio may be stored as a percentage (as in the above example), a decimal number (e.g., 0.45), or a pair of two numbers (e.g., {6.75, 15.00}) where one number in the pair corresponds to the incremental value and the other number corresponds to the direct amount. By retaining the pair of numbers on a per content provider, per simulated event basis, the same incremental value ratio may be used multiple times to calculate different aggregated incremental value ratios for the content provider, as described in more detail below.

### Supported Amount

In an embodiment, an incremental value is calculated for a particular content provider based on an amount that one or more other content providers would have compensated content delivery exchange 120 if the particular content provider did not participate in one or more content item selection events, in which content item(s) of the one or more other content providers were selected for presentation. This amount is referred to herein as a “supported amount.” For example, a difference between (1) an amount that content provider 114 did compensate content delivery exchange 120 for a content item selection event and (2) an amount that content provider 114 would have compensated content delivery exchange 120 for the content item selection event if content provider 112 did not participate in the content item selection event is used to calculate an incremental value for content provider 112.

Thus, a supported amount may be determined for a content provider on an individual content item selection event basis and/or a group (of content item selection events) basis. For example, a supported amount for a content provider may be calculated for all content item selection events that occurred within the last fourteen days.

Table C illustrates a simulated content item selection event that is based on the example content item selection event of Table A. In this simulated event, content provider B (or one of its content items) does not participate in the simulated content item selection event, but, as a result, content provider F (or one of its content items) would have participated:

TABLE C

| | | | | Revenue | |
|---|---|---|---|---|---|
| Auction | Content | | Campaign | (predicted | |
| Position | Provider | Bid | Floor | eCPM) | Scroll |
| 1 | A | 20.00 | 10.00 | 12.00 | 1 |
| 2 | B | | | | |
| 3 | C | 12.00 | 12.00 | 12.00 | 1 |
| 4 | D | 10.00 | 9.50 | 9.50 | 1 |
| 5 | E | 9.00 | 2.00 | 8.50 | 1 |
| 6 | F | 8.50 | 2.00 | 8.25 | 1 |
| 7 | G | 8.25 | 2.00 | 0 | 0 |
| 8 | H | 8.20 | 2.00 | 0 | 0 |
| 9 | I | 8.15 | 2.00 | 0 | 0 |
| 10 | J | 8.00 | 2.00 | 0 | 0 |
| | | | Total | 50.25 | |

In this simulated event, the direct amount of content provider B is 12.00 units and the replacement amount is 8.25 units. In other words, removing content provider B results in 12.00 units being lost. However, content provider F would have had an opportunity in this simulated event to have one of its content items selected for display; thus, there is a gain (or replacement amount) of 8.25 units. Furthermore, in this simulated event, content provider A only has to compensate content delivery exchange 120 12.00 units instead of 15.00 units because the next highest bid after content provider A's bid is content provider C's bid, which is 12.00 units. This difference between 15.00 units and 12.00 units is the “supported amount.” Therefore, the incremental value for content provider B with respect to this content item selection event is 12.00−8.25+3.00=6.75 units. Thus, an incremental value is a difference between (1) the sum of the direct amount(s) and supported amount(s) and (2) the replacement amount(s). An incremental value ratio for content provider B may be calculated for this content item selection event, which may be 6.75/12.00=56.25%.

Table D illustrates a simulated content item selection event that is based on the example content item selection event of Table A:

TABLE D

| | | | | Revenue | |
|---|---|---|---|---|---|
| Auction | Content | | Campaign | (predicted | |
| Position | Provider | Bid | Floor | eCPM) | Scroll |
| 1 | A | 20.00 | 10.00 | 15.00 | 1 |
| 2 | B | 15.00 | 10.00 | 12.00 | 1 |
| 3 | C | 12.00 | 12.00 | 12.00 | 1 |
| 4 | D | 10.00 | 9.50 | 9.50 | 1 |
| 5 | E | 9.00 | 2.00 | 8.25 | 1 |
| 6 | F | | | | |
| 7 | G | 8.25 | 2.00 | 0 | 0 |
| 8 | H | 8.20 | 2.00 | 0 | 0 |
| 9 | I | 8.15 | 2.00 | 0 | 0 |
| 10 | J | 8.00 | 2.00 | 0 | 0 |
| | | | Total | 50.25 | |

In neither the actual event or the simulated event is one of content provider F's content items selected for presentation. Thus, no “direct amount” is lost and no replacement amount is realized. However, content provider F's absence from the simulated content item selection event results in a supported amount being lost.

In this simulated event, removing content provider F results in content provider E compensating content delivery exchange 120 8.25 units instead of 8.50 units. This difference between 8.50 units and 8.25 units is another example of the “supported amount.” Therefore, in this content item selection event, the incremental value for content provider F is 0.25 units. A percentage or decimal version of an incremental value ratio for content provider F cannot be calculated since the denominator (representing direct amount) is 0 and dividing by 0 does not yield a real number. However, aggregating direct amounts, replacement amounts, and supported amounts across multiple simulated content item selection events will allow an incremental value ratio to be computed.

Generally, incremental value ratios for content providers that participate in high competition content item selection events (where bids are relatively close together and/or replacement content providers exist) will be lower than incremental value ratios for content providers that participate in low competition content item selection events where bids are relatively far apart and/or there are few if any replacement content providers.

### Event Simulator and Analyzer

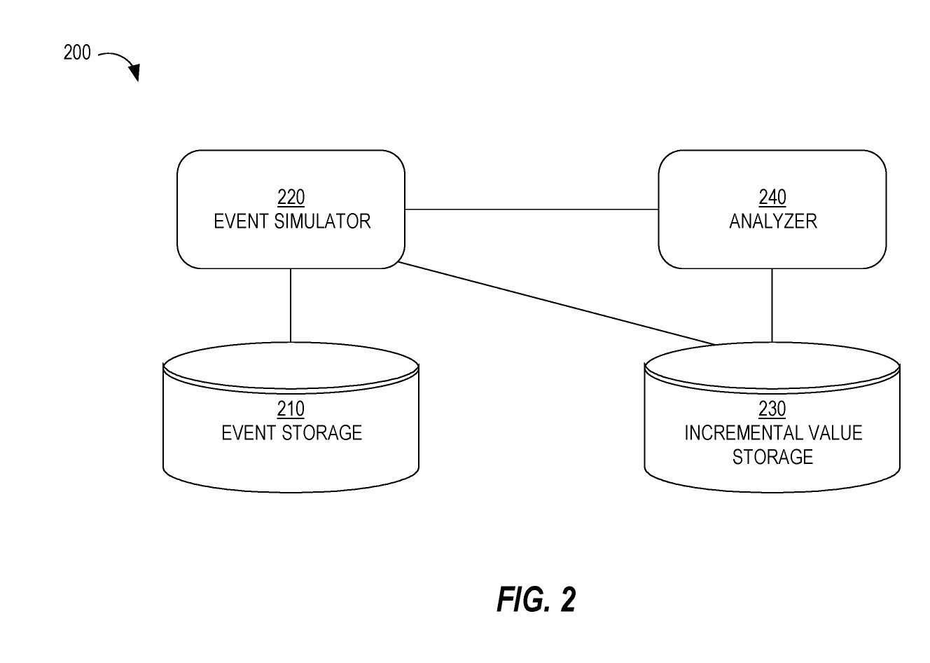

FIG. 2 is a block diagram that depicts an event simulation system 200, in an embodiment. Event simulation system 200 includes event storage 210, event simulator 220, incremental value storage 230, and analyzer 240. Content delivery exchange 120 stores results of each (actual) content item selection event into event storage 210. The results of each content item selection event may comprise the type of information found in Table A, such as position, content provider identifier and/or campaign identifier, bid, campaign floor, bid, revenue, floor, and whether the corresponding content item was selected for presentation. Thus, the results of a single event may include information about campaigns or content providers that were not ultimately selected for presentation.

Event simulator 220 retrieves content item selection events from event storage 210. For each retrieved content item selection event, event simulator 220 simulates or replays an content item selection event by removing one of the content items or campaigns that participated in the content item selection event and determining how the content item selection event would have been conducted without the removed content item. Event simulator 220 determines the content item or campaign based on input, such as user input that identifies a particular content provider (e.g., a unique content provider identifier), a particular campaign (e.g., a unique content delivery campaign identifier), or a particular content item (e.g., a unique content item identifier). Once the provider/campaign/item is identified, all content item selection events in which that provider/campaign/item participated are identified and simulated by removing the provider/campaign/item from consideration. An incremental value ratio is then computed based on the results of the simulated events. Thus, event simulator 220 may be invoked by explicit user input for each incremental value ratio computed.

Additionally or alternatively, event simulator 220 may be programmed to compute incremental value ratios continuously without requiring specific user input for each incremental value ratio computed. For example, event simulator 220 may simulate, for each content provider in a set of content providers, all content item selection events that occurred on a particular day in which the content provider participated. The set of content providers may be all content providers with active campaigns or may be a subset thereof. The set of content providers may change from time to time based on user input.

Event simulator 220 is implemented in hardware, software, or any combination of hardware and software. Event simulator 220 may be implemented on a single computing device or on multiple computing devices that perform the same set of operations or a different set of operations.

Event simulator 220 stores computed incremental value ratios in incremental value storage 230. Event storage 210 and incremental value storage 230 may be a file system, a relational database, an object database, a No SQL database, or any other type of data storage. The data in storage 230 may be organized in one of many ways. For example, a record or row be store a single incremental value ratio for a particular content item, campaign, or content provider. Other fields or column of the record or row may include a content item identifier (if the incremental value ratio is for a particular content item), a content delivery campaign identifier (if the incremental value ratio is for a particular campaign), a content provider identifier (if the incremental value ratio is for a particular content provider), a time range (e.g., a particular hour, day, month), and, optionally, an aggregated indicator that indicates whether the corresponding incremental value ratio is based on other computed incremental value ratios. Aggregation of incremental value ratios is described in more detail herein.

Analyzer 240 reads incremental value ratios from incremental value storage 230, performs one or more analysis options on the read ratios, and generates a report. Analyzer 240 may invoke or call event simulator 220 in order to generate additional incremental value ratios and store the generated ratios in storage 230. Analyzer 240 may invoke event simulator 220 only when analyzer 240 determines that the required incremental value data is not available in storage 230. In an embodiment, only analyzer 240 causes event simulator 220 to perform the simulations and generate the incremental value ratios.

In an embodiment, analyzer 240 accepts user input that specifies one or more criteria, such as one or more particular content providers/campaigns/content items, a time range, and/or one or more other criteria that limits which content item selection events will be simulated (e.g., by user attribute or by content provide attribute, such as geographic region). Examples of criteria are provided herein.

Analyzer 240 is implemented in hardware, software, or any combination of hardware and software. Analyzer 240 may be implemented on a single computing device or on multiple computing devices that perform the same set of operations or a different set of operations. Although displayed separately from event simulator 220, analyzer 240 may be a component of event simulator 220.

### Example Process

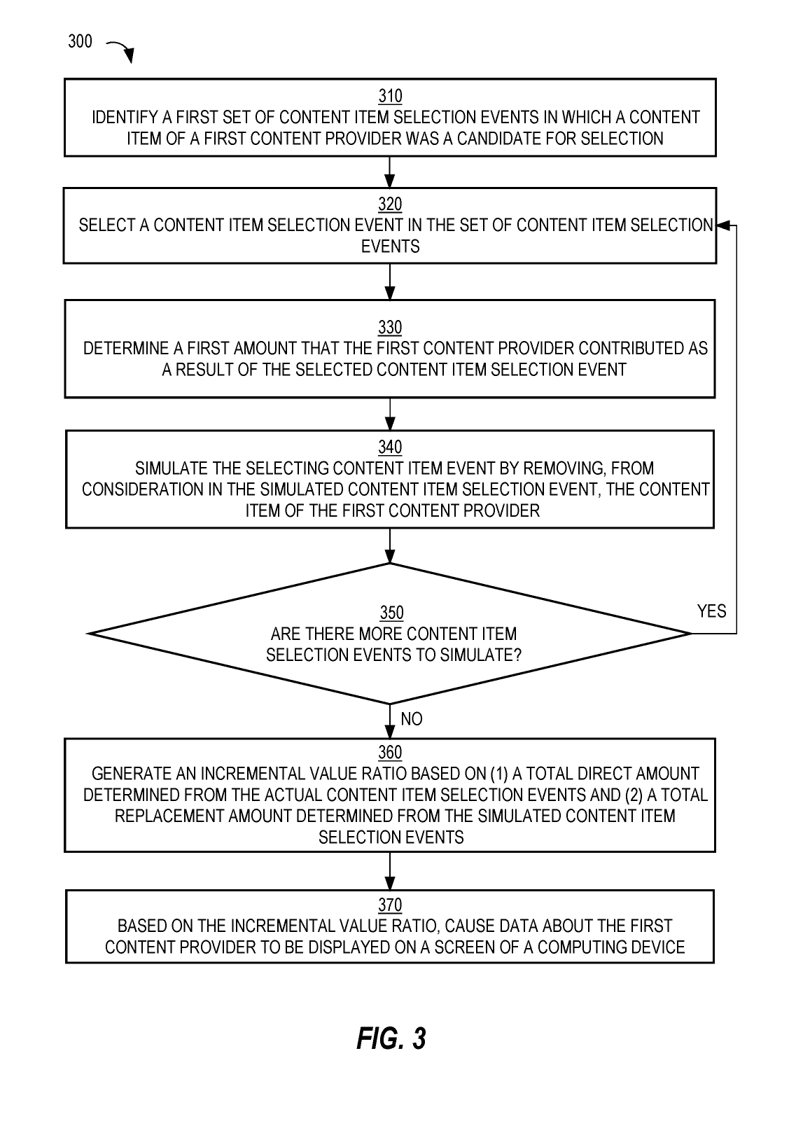

FIG. 3 is a flow diagram that depicts an example process 300 for simulating content item selection events, in an embodiment. Process 300 may be performed, at least partially, by event simulator 220.

At block 310, a first set of content item selection events in which a content item of a first content provider was a candidate for selection is identified. Block 310 may be performed in response to receiving user input that specifies the content item, the campaign to which the content item belongs, or the first content provider. Event simulator 220 may have received the user input directly or indirectly through analyzer 240.

At block 320, one of the identified content item selection events is selected. The order in which a content item selection event is selected for simulation is not important.

At block 330, a first amount that the first content provider contributed to the selected content item selection event is determined. A total direct amount is set to the first amount determined during the first iteration of block 330. Prior to the first iteration of block 330, the total direct amount is zero. For each subsequent iteration of block 330 for the set of content item selection events that was identified in block 310, the total direct amount is incremented by the first amount determined during that subsequent iteration. For example, if the first iteration of block 330 resulted in a first amount of 15 units and the second iteration of block 330 resulted in a first amount of 12 units, then the total direct amount after the second iteration of block 330 is (15+12)=27 units.

At block 340, the content item selection event is simulated or replayed by removing the content item of the first content provider from consideration in the simulated event. Block 340 involves determining a second amount that a different content provider different than the first content provider would have contributed to the selected content item selection event if the different content provider was selected for the simulated content item selection event instead of the first content provider. A content item from the different content provider was not considered during the actual content item selection event.

A total replacement amount is set to the second amount determined during the first iteration of block 340. Prior to the first iteration of block 340, the total replacement amount is zero. For each subsequent iteration of block 340 for the set of content item selection events that was identified in block 310, the total replacement amount is incremented by the second amount determined during that subsequent iteration. For example, if the first iteration of block 340 resulted in a second amount of 11 units and the second iteration of block 340 resulted in a second amount of 8 units, then the total replacement amount after the second iteration of block 340 is (11+8)=19 units.

At block 350, it is determined whether there are any more content item selection events in the identified set that have not been simulated. If so, process 300 returns to block 330; otherwise process 300 proceeds to block 360.

At block 360, an incremental value ratio is determined based on the total direct amount and the total replacement amount. The ratio may be a pair of numbers of a computation that divides one number by another. For example, an incremental value ratio may be determined by subtracting the total replacement amount from the total direct amount and then dividing that difference with the total direct amount. If the resulting value is relatively small, then the first content provider (or the content item or campaign) has relatively small incremental value.

At block 370, based on the incremental value ratio, cause data about the first content provider to be displayed on a screen of a computing device, such as a desktop computer, a laptop computer, or a smartphone. Block 370 may be performed by analyzer 240 and may comprise sending the data over a computer network, such as a LAN or the Internet.

In a related embodiment, process 300 involves determining (e.g., before block 350), a third amount that another content provider, that is different than the first content provider and that did participate in the content item selection event, would have contributed if the first content provider was not selected for the content item selection event. This third amount is subtracted from a fourth amount that the other content provider did contribute as a result of its content item being selected for presentation. The difference between the fourth amount and the third amount is the supported amount for this content item selection event. A content provider might not have any supported amount for some content item selection events (e.g., if the content provider's content item was the top selected content item) or if the content provider did not “support” any content providers whose content items were selected. As illustrated in an example above, even though a content provider's content item might not have been selected for presentation, that content item may have influenced an amount contributed by another content provider whose content item was selected for presentation.

A total supported amount is set to the difference determined during the first iteration of this determination. Prior to the first iteration of this difference determination, the total supported amount is zero. For each subsequent iteration of this difference determination for the set of content item selection events that was identified in block 310, the total supported amount is incremented by the difference determined during that subsequent iteration. For example, if the first iteration resulted in a difference (or supported amount) of 2 units and the second iteration resulted in a difference (or supported amount) of 1 units, then the total supported amount after the second iteration is (2+1)=3 units.

In content item selection events in which a content provider may have participated but whose content item was not selected, the content provider may be associated with a supported amount but, by definition, not a direct amount or a replacement amount. In content item selection events in which a content provider participated and whose content item was selected, the content provided is associated with a direct amount and a replacement amount, but may or may not be associated with a supported amount.

### Incremental Value Ratio Based on Certain Groups of Content Item Selection Events

Previously, an example was given of generating an incremental value ratio for a particular content provider for the most recent group of simulated content item selection events conducted over a certain time. Thus, a content provider may be associated with multiple incremental value ratios, one for each different set of simulated content item selection events. For example, content provider 112 may be associated with a different incremental value ratio for each month of the year. As another example, an incremental value ratio may be calculated for content provider 112 based on simulating content item selection events that occurred only on weekends (a “weekend incremental value ratio”) and an incremental value ratio may be calculated for content provider 112 based on simulating content item selection events that occurred only on weekdays (a “weekday incremental value ratio”).

In an embodiment, an incremental value ratio is computed for a content provider based on simulated content item selection events that satisfy one or more criteria other than time. Criteria may include user attributes, such as geography of the user or client device through which is presented (e.g., displayed) the selected content item(s), an industry of the user, a job title of the user, an employer of the user, an academic degree of the user, an academic institution attended by the user, and one or more skills of the user. Such user attributes may be specified in the user's profile. Geography may be one or more levels of granularity, such as a large geographic region (e.g., Europe or North America), an individual country (e.g., France), a province or state, a city, a zip code, or an area code. Thus, for example, a content provider may be associated with an incremental value ratio for users in Europe and another incremental value ratio for users with a graduate degree.

### Incremental Value Ratio for a Group of Content Providers

In an embodiment, a single incremental value ratio is computed for a set of two or more content providers. The content item selection events that are simulated are ones in which at least one of the content providers in the set participated and optionally, may be limited by time (e.g., the last twelve hours) and/or by user attribute. Some content item selection events may have content items from multiple content items in the set or group of content providers.

The set of content providers may be determined based on one or more attributes of content providers, such as geography (e.g., US, Europe, China, South America), industry associated with the content provider (e.g., finance, travel, technology), company size (e.g., between 50-99 or between 1,000-20,000), stock price, types of users that the content provider targets (e.g., graduate degree holders, unemployed, tech background), etc.

The single incremental value ratio may be computed by first computing individual incremental value ratios for each content provider in the group and then aggregating the individual incremental value ratios.

### Campaign Incremental Value Ratio

Embodiments described herein involve simulating content item selection events on a per content provider basis. In a related embodiment, content item selection events are simulated on a per content delivery campaign basis. Thus, if a particular content provider has initiated multiple content delivery campaigns, then the particular content provider may be associated with multiple “campaign values.” Consequently, different content delivery campaigns may be associated with different incremental value ratios, especially if each of the different content delivery campaigns is associated with a different target audience and, therefore, participates in very different content item selection events than other content delivery campaigns from the same content provider.

### Aggregating Results of Individual Simulated Events

In an embodiment, an incremental value ratio is computed at low levels of granularity (e.g., for each individual content item selection event) and later aggregated in one or more ways to generate an incremental value ratio at a higher level of granularity. For example, a first incremental value ratio is computed for content provider 112 for a first content item selection event and a second incremental value ratio is computed for content provider 112 for a second content item selection event. Both events may have occurred on the same day. Later, if a user or administrator of content delivery exchange 120 requests data that requires a calculation of an incremental value ratio of content provider 112 for that day, then the two incremental value ratios may be aggregated to generate an aggregated incremental value ratio. If the first event occurred with respect to geographic region A, the second event occurred with respect to geographic region B, and a user or administrator of content delivery exchange 120 requests data that requires a calculation of an incremental value ratio of content provider 112 for geographic region A, then only the first incremental value ratio (and not the second incremental value ratio) is used to calculate an aggregated incremental value ratio for geographic region A. Thus, the same (base) incremental value ratio may be used to compute different aggregated incremental value ratios.

Aggregating multiple incremental value ratios may involve calculating an average or determining a median of multiple decimal versions of the incremental value ratios. For example, the average of 0.45 and 0.57 is 0.51. Alternatively, aggregating multiple incremental value ratios may involve separately (1) adding the direct amounts of the multiple incremental value ratios and (2) adding the incremental values of the multiple incremental value ratios, and then performing a division between both sums.

### Effective Demand Generation

An incremental value and/or an incremental value ratio has many potential uses. For example, without an understanding of incremental value, there is no distinction, from the perspective of the party or entity that operates or manages content delivery exchange 120 (referred to herein as the “exchange entity”) between low incremental ROI marketing channels and high incremental ROI marketing channels. Examples of online marketing channels for the exchange entity include search engine marketing (SEM), traditional display advertising, SEO/organic traffic, email marketing, affiliate networks, and social media marketing.

Resources may be inadvertently directed to low incremental ROI channels. For example, in order to attract additional content providers, the exchange entity might bid on keywords at a search engine website. If a user (e.g., a representative of a potential/prospective content provider) enters a keyword, then a content item (e.g., an advertisement) from the exchange entity may be displayed to the user, enticing the user to register a content provider with content delivery exchange 120. Another way to attract additional content providers is through display advertising, such as registering with a third-party content delivery exchange or directly with a third-party publisher. Through different marketing channels, the exchange entity attracts a different set of content providers to content delivery exchange 120. Thus, each marketing channels is associated with a different set of content providers.

Examples of offline marketing channels include TV, radio, billboards, newspaper, etc. Such channels may benefit from the approaches herein if the offline channel can be tracked via promotion codes or some other method.

A total incremental value (or incremental value ratio) may be computed for each marketing channel by determining, for each marketing channel, an incremental value (or incremental value ratio) of each content provider associated with that marketing channel. If one marketing channel is associated with a higher incremental value (or higher incremental value ratio), then more resources (e.g., dollars or person hours) may be devoted or allocated to that marketing channel and/or resources may be deallocated from a lower incremental ROI marketing channel.

In the SEM context, each content provider that originates from SEM efforts is mapped to a keyword or set of keywords that was used to inform that content provider about the service provided by content delivery exchange 120. Then, for each keyword or set of keywords, an aggregated incremental value (or aggregated incremental ratio) is determined for a set of content providers that is mapped to (or otherwise associated with) the keyword or set of keywords. The keyword or set of keywords associated with the highest aggregated incremental value (or highest aggregated incremental value ratio) is identified. Therefore, more resources are devoted to the identified keyword or set of keywords and/or less resources are devoted to lower ranked keyword(s).

### Effective Content Provider Management and Prioritization

A content delivery exchange may support many (e.g., hundreds or thousands) different content providers. In an ideal world, a content delivery exchange has unlimited resources to help each content provider in reaching their respective goals and to respond to their requests for support. However, such resources are limited. Therefore, (e.g., manual or personal) support of a group of content providers should be prioritized. Understanding which content providers are creating the most incremental value will help a content delivery exchange to prioritize support and focus resources optimally.

In an embodiment, a set of content providers is ranked based on incremental value ratio. The higher the incremental value ratio of a content provider, the higher that content provider will appear in a list of content providers. The set of content providers to rank may be established by considering all content providers. Including all content providers in the set may be a default setting. Alternatively, a default set of content providers to rank may be any content provider that has a currently active campaign or that had an active campaign in the last period of time (e.g., the last three days). Alternatively still, the set of content providers to rank may be content providers that have submitted requests for support. A ranking of content providers may be updated daily (e.g., based on updated incremental value ratios), whenever a new content provider is added to the set (e.g., due to a submission of a request for support from that content provider), and/or whenever a content provider is removed from the set (e.g., due to their request for support being processed.)

In a related embodiment, a user or administrator of content delivery exchange 120 may specify one or more criteria that a content provider must satisfy in order to be included in the set, such as content providers whose campaigns participated in content item selection events for Chinese users and/or content providers whose campaigns target users in the financial industry. Other example criteria include a type of content presented as part of the corresponding campaign (e.g., text, video, audio), a product type of the corresponding campaign (e.g., sponsored update, dynamic content item, content items from other (third party) content delivery exchanges), and whether a bid price of the corresponding campaign falls within a certain range (e.g., $5-$7 or $7-$10).

In a related embodiment, incremental value ratio is one of multiple factors that are used to rank a set of content providers. Other factors may include a class of audience or industry that the content provider targets. For example, a first content provider with a first class target audience may be ranked higher than a second content provider with a second class target audience even though the incremental value ratio of the first content provider is lower than the incremental value ratio of the second content provider.

### Forecasting and Performance Management

If a content provider terminates one or more content delivery campaigns, then revenue for the exchange entity may or may not significantly decrease. Without embodiments herein for calculating an incremental value ratio for a content provider or a content delivery campaign, the departure of a content provider from content delivery exchange 120 may be given as a major (or the sole) reason for a corresponding drop in revenue. For example, if a content provider compensates content delivery exchange 120 an average of 100K units per day and content delivery exchange 120 experiences a 90K unit drop the day after that content provider leaves, then some might presume that the content provider is the primary cause of the 90K unit drop. However, if that content provider has an incremental value ratio of 10%, then only roughly 10K of the 90K unit drop should be attributed to the departure of that content provider.

Indeed, a unit drop may have multiple causes other than one or more content providers ceasing to use content delivery exchange 120. For example, a software bug in content delivery exchange 120 may cause fewer content delivery campaigns from being considered during content item selection events. As another example, a software bug may result in generating a poor prediction model for predicting user selection rates of different content items, resulting in lower quality content items being selected in content item selection events. As another example, a hardware bug may result in much fewer content requests being received from a certain high quality geographic area. Incorrectly attributing unit drops to fewer content providers or fewer active content delivery campaigns may result in actual system problems being overlooked and left uncorrected. Such neglect may have disastrous effects on user experience and/or revenue.

### Fake Content Delivery Campaign

Embodiments described herein involving simulating content item selection events are directed to the scenario of removing an actual or existing content provider's campaign from a set of candidate campaigns of a content item selection event and determining an impact of that removal by considering direct amount lost, replacement amount gained, and supported amount lost.

In a related embodiment, simulating a content item selection event involves adding one or more additional (but not yet existing) campaigns to a set of candidate campaigns for a content item selection event that occurred in the past. Such additional campaigns do not exist but can be modeled based on existing campaigns. Simulating a content item selection event by adding a “fake” campaign results in computing similar metrics discussed above for the fake campaign, including a direct amount, a replacement amount, and a supported amount. Thus, an incremental value and an incremental value ratio can be computed for a fake campaign (from an actual or hypothetical content provider), especially over multiple simulated content item selection events. With this approach, an administrator of content delivery exchange 120 can ask and answer the question regarding what impact one or more additional content providers (that are similar to, for example, content provider 112) might have on revenue.

Instead of computing an incremental value or incremental value ratio for one or more fake campaigns or content providers, a difference between (a) revenue generated by a set of actual content item selection events and (b) revenue generated by a simulated version of that set is computed. The difference may be displayed on a screen of a computing device. Additionally or alternatively, a ratio between the difference and the revenue generated by the set of actual content item selection events is computed and displayed.

In a related embodiment, simulating with fake campaigns (or fake content providers) may involve modifying some of the attributes of the fake campaigns, such as having a different bid price and/or a different floor price (or none at all). For example, adding a content provider that is similar to content provider 114 but with 75% of the bid price of content provider 114 might result in a similar incremental value ratio as adding a content provider that is similar to content provider 114 but with 100% of the bid price of content provider 114 and no campaign floor.

### Fake Content Item Selection Events

Examples above involve simulating (or replaying past) content item selection events by removing or adding a content delivery campaign. In an embodiment, an impact is determined for conducting one or more fake content item selection events (or “incremental auctions”) based on existing content delivery campaigns. With this approach, an administrator of content delivery exchange 120 can ask and answer the question regarding what impact additional content item selection events might have on revenue. For example, input that specifies targeting criteria (of a particular target audience) is received and multiple content item selection events are conducted, though not in response to “real” content requests. Instead, a number of content item selection events is determined (e.g., based on user input) and the targeting criteria are used to simulate that number of content item selection events. A total revenue amount from the simulated content item selection events is determined and displayed on a screen of a computing device of, for example, an administrator of content delivery exchange 120.

By simulating such fake content item selection events (or incremental auctions), it can be determined which content providers will drop out of content item selection events due to hitting their respective budgetary caps (if any). Also, revenue generated from incremental auctions can be determined as well as how the incremental value of a content provider changes with such incremental auctions. Using this approach, one can ask and answer the question regarding what impact a, for example, doubling of supply (i.e., regarding number of content item selection events) given existing demand (i.e., in the form of the current number content delivery campaigns and their respective budgets) might have on generated revenue. This approach may help inform whether certain markets are supply constrained or demand constrained (whether increasing supply in those markets should be prioritized over increasing demand or vice versa).

### Improvements to Computer-Related Technology

Simulating content item selection events according to approaches described herein represents an improvement in computer-related technology and is a technical solution to a technical problem. Calculating incremental values or incremental value ratios (based on either replacement amounts, supported amounts, or both) for different content providers may result in numerous technical advantages, such as reducing the allocation of valuable computing resources and other resources dedicated to some content providers.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

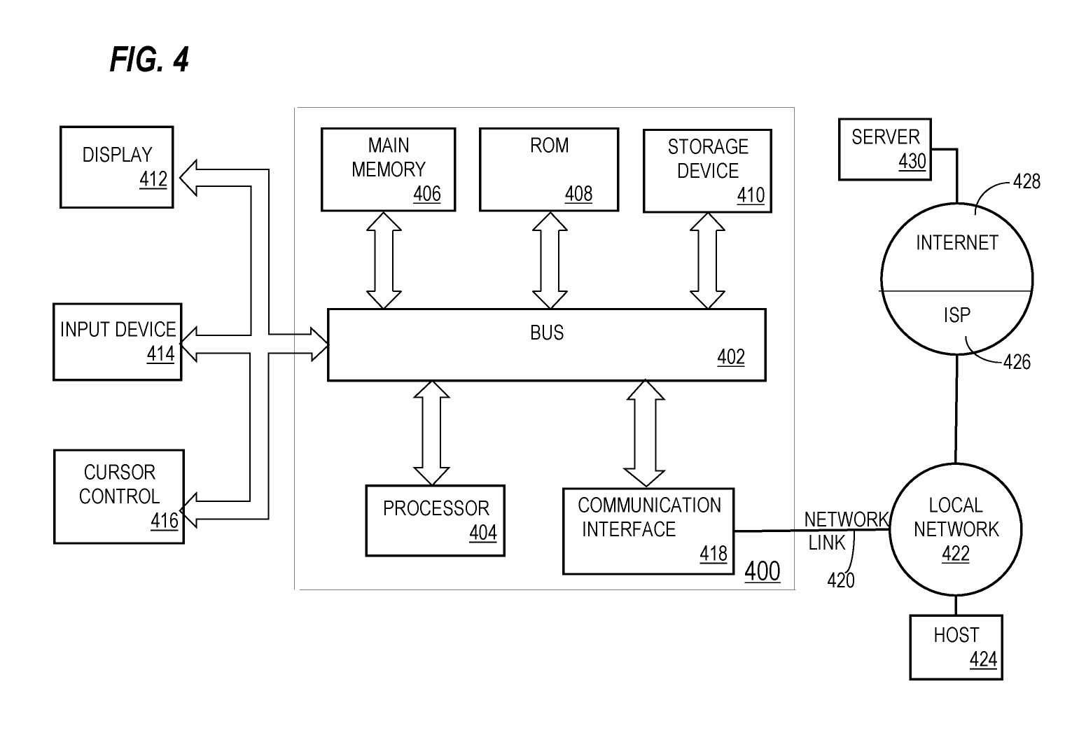

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more computer-readable media storing instructions which, when executed by the one or more processors, cause:
identifying a first plurality of content item selection events in which a content item of a first content provider was a candidate for selection;
for each content item selection event of the first plurality of content item selection events:
determining a first amount that the first content provider contributed to said each content item selection event;
simulating said each content item selection event by removing the content item of the first content provider from consideration, wherein simulating comprises determining a second amount that a different content provider different than the first content provider would have contributed to said each content item selection event if the different content provider was selected for said each content item selection event instead of the first content provider;
determining a first total of the first amounts determined for the first plurality of content item selection events;
determining a second total of the second amounts determined for the first plurality of content item selection events;
based on the first total and the second total, calculating a first incremental value for the first content provider;
calculating a first ratio of the first incremental value to the first total;
based on the first ratio, causing data about the first content provider to be displayed on a screen of a computing device.

2. The one or more storage media of claim 1, wherein the first plurality of content item selection events includes a content item selection event in which a content item of the first content provider was not selected for presentation.

3. The one or more storage media of claim 1, wherein the instructions, when executed by the one or more processors, further cause:
identifying a second plurality of content item selection events in which a content item of a second content provider that is different than the first content provider was a candidate for selection;
for each content item selection event of the second plurality of content item selection events:
determining a third amount that the second content provider contributed to said each content item selection event;
simulating said each content item selection event by removing the content item of the second content provider from consideration, wherein simulating comprises determining a fourth amount that another content provider different than the second content provider would have contributed to said each content item selection event if the other content provider was selected for said each content item selection event instead of the second content provider;
determining a third total of the third amounts determined for the second plurality of content item selection events;
determining a fourth total of the fourth amounts determined for the second plurality of content item selection events;
based on the third total and the fourth total, calculating a second incremental value for the second content provider;
calculating a second ratio of the second incremental value to the third total;
ranking the first content provider and the second content provider based on the first ratio and the second ratio.

4. The one or more storage media of claim 1, wherein the instructions, when executed by the one or more processors, further cause:
identifying a second plurality of content item selection events in which a content item of a second content provider that is different than the first content provider was a candidate for selection;
for each content item selection event of the second plurality of content item selection events:
determining a third amount that the second content provider contributed to said each content item selection event;
simulating said each content item selection event by removing the content item of the second content provider from consideration, wherein simulating comprises determining a fourth amount that another content provider different than the second content provider would have contributed to said each content item selection event if the other content provider was selected for said each content item selection event instead of the second content provider;
determining a third total of the third amounts determined for the second plurality of content item selection events;
determining a fourth total of the fourth amounts determined for the second plurality of content item selection events;
receiving input that selects a particular geographic region that is different than a plurality of other geographic regions;
wherein the first content provider and the second content provider are associated with the particular geographic region;
in response to receiving the input, generating an aggregated ratio based on the first amounts determined for the first plurality of content item selection events, the second amounts determined for the first plurality of content item selection events, the third amounts determined for the second plurality of content item selection events, and the fourth amounts determined for the second plurality of content item selection events;
causing the aggregated ratio to be displayed on the screen of the computing device.

5. The one or more storage media of claim 1, wherein the first plurality of content item selection events are identified based on each content item selection event in the first plurality being conducted in a first time period, wherein the instructions, when executed by the one or more processors, further cause:
identifying a second plurality of content item selection events in which a content item of the first content provider was a candidate for selection;
wherein the second plurality of content item selection events are identified based on each content item selection event in the second plurality being conducted in a second time period that is different than the first time period;
for each content item selection event of the second plurality of content item selection events:
determining a third amount that the first content provider contributed to said each content item selection event;
simulating said each content item selection event by removing the content item of the first content provider from consideration, wherein simulating comprises determining a fourth amount that another content provider different than the first content provider would have contributed to said each content item selection event if the other content provider was selected for said each content item selection event instead of the first content provider;
receiving input that selects a particular time period that is different than a plurality of other time periods;
in response to receiving the input, generating an aggregated ratio based on the first amounts determined for the first plurality of content item selection events, the second amounts determined for the first plurality of content item selection events, the third amounts determined for the second plurality of content item selection events, and the fourth amounts determined for the second plurality of content item selection events;
based on the aggregated ratio, causing second data about the first content item provider to be displayed on the screen of the computing device.

6. The one or more storage media of claim 1, wherein:
simulating a particular content item selection event in the first plurality of content item selection events further comprises:
determining a third amount that a third content provider, that is different than the first content provider and that did participate in said each content item selection event, did contribute in said each content item selection event;
determining a fourth amount that the third content provider would have contributed if the first content provider was not selected for said each content item selection event;
determining a difference between the third amount and the fourth amount;
calculating the first incremental value is also based on the difference.

7. The one or more storage media of claim 6, wherein the first content provider did not participate in the particular content item selection event.

8. The one or more storage media of claim 1, wherein the instructions, when executed by the one or more processors, further cause:
storing a first association between a first plurality of content providers and a first channel;
generating a first aggregated incremental value ratio for the first plurality of content providers;
storing a second association between a second plurality of content providers and a second channel;
generating a second aggregated incremental value ratio for the second plurality of content providers;
based on the first aggregated incremental value ratio and the second aggregated incremental value ratio, ranking the first channel relative to the second channel.

9. The one or more storage media of claim 1, wherein the instructions, when executed by the one or more processors, further cause:
associating a first plurality of content providers with a first keyword;
generating a first aggregated incremental value ratio for the first plurality of content providers;
associating a second plurality of content providers with a second keyword;
generating a second aggregated incremental value ratio for the second plurality of content providers;
based on the first aggregated incremental value ratio and the second aggregated incremental value ratio, ranking the first keyword relative to the second keyword.

10. The one or more storage media of claim 1, wherein the first plurality of content item selection events includes only content item selection events in which a content item of the first content provider was selected for presentation.

11. A method comprising:
identifying a first plurality of content item selection events in which a content item of a first content provider was a candidate for selection;
for each content item selection event of the first plurality of content item selection events:
determining a first amount that the first content provider contributed to said each content item selection event;
simulating said each content item selection event by removing the content item of the first content provider from consideration, wherein simulating comprises determining a second amount that a different content provider different than the first content provider would have contributed to said each content item selection event if the different content provider was selected for said each content item selection event instead of the first content provider;
determining a first total of the first amounts determined for the first plurality of content item selection events;
determining a second total of the second amounts determined for the first plurality of content item selection events;
based on the first total and the second total, calculating a first incremental value for the first content provider;
calculating a first ratio of the first incremental value to the first total;
based on the first ratio, causing data about the first content provider to be displayed on a screen of a computing device.

12. The method of claim 11, wherein the first plurality of content item selection events includes a content item selection event in which a content item of the first content provider was not selected for presentation.

13. The method of claim 11, further comprising:
identifying a second plurality of content item selection events in which a content item of a second content provider that is different than the first content provider was a candidate for selection;
for each content item selection event of the second plurality of content item selection events:
determining a third amount that the second content provider contributed to said each content item selection event;
simulating said each content item selection event by removing the content item of the second content provider from consideration, wherein simulating comprises determining a fourth amount that another content provider different than the second content provider would have contributed to said each content item selection event if the other content provider was selected for said each content item selection event instead of the second content provider;
determining a third total of the third amounts determined for the second plurality of content item selection events;
determining a fourth total of the fourth amounts determined for the second plurality of content item selection events;
based on the third total and the fourth total, calculating a second incremental value for the second content provider;
calculating a second ratio of the second incremental value to the third total;
ranking the first content provider and the second content provider based on the first ratio and the second ratio.

14. The method of claim 11, further comprising:
identifying a second plurality of content item selection events in which a content item of a second content provider that is different than the first content provider was a candidate for selection;
for each content item selection event of the second plurality of content item selection events:
determining a third amount that the second content provider contributed to said each content item selection event;
simulating said each content item selection event by removing the content item of the second content provider from consideration, wherein simulating comprises determining a fourth amount that another content provider different than the second content provider would have contributed to said each content item selection event if the other content provider was selected for said each content item selection event instead of the second content provider;
determining a third total of the third amounts determined for the second plurality of content item selection events;
determining a fourth total of the fourth amounts determined for the second plurality of content item selection events;
receiving input that selects a particular geographic region that is different than a plurality of other geographic regions;
wherein the first content provider and the second content provider are associated with the particular geographic region;
in response to receiving the input, generating an aggregated ratio based on the first amounts determined for the first plurality of content item selection events, the second amounts determined for the first plurality of content item selection events, the third amounts determined for the second plurality of content item selection events, and the fourth amounts determined for the second plurality of content item selection events;
causing the aggregated ratio to be displayed on the screen of the computing device.

15. The method of claim 11, wherein the first plurality of content item selection events are identified based on each content item selection event in the first plurality being conducted in a first time period, the method further comprising:
identifying a second plurality of content item selection events in which a content item of the first content provider was a candidate for selection;
wherein the second plurality of content item selection events are identified based on each content item selection event in the second plurality being conducted in a second time period that is different than the first time period;
for each content item selection event of the second plurality of content item selection events:
determining a third amount that the first content provider contributed to said each content item selection event;
simulating said each content item selection event by removing the content item of the first content provider from consideration, wherein simulating comprises determining a fourth amount that another content provider different than the first content provider would have contributed to said each content item selection event if the other content provider was selected for said each content item selection event instead of the first content provider;
receiving input that selects a particular time period that is different than a plurality of other time periods;
in response to receiving the input, generating an aggregated ratio based on the first amounts determined for the first plurality of content item selection events, the second amounts determined for the first plurality of content item selection events, the third amounts determined for the second plurality of content item selection events, and the fourth amounts determined for the second plurality of content item selection events;
based on the aggregated ratio, causing second data about the first content item provider to be displayed on the screen of the computing device.

16. The method of claim 11, wherein:
simulating a particular content item selection event in the first plurality of content item selection events further comprises:
determining a third amount that a third content provider, that is different than the first content provider and that did participate in said each content item selection event, did contribute in said each content item selection event;
determining a fourth amount that the third content provider would have contributed if the first content provider was not selected for said each content item selection event;
determining a difference between the third amount and the fourth amount;
calculating the first incremental value is also based on the difference.

17. The method of claim 16, wherein the first content provider did not participate in the particular content item selection event.

18. The method of claim 11, further comprising:
storing a first association between a first plurality of content providers and a first channel;
generating a first aggregated incremental value ratio for the first plurality of content providers;
storing a second association between a second plurality of content providers and a second channel;
generating a second aggregated incremental value ratio for the second plurality of content providers;
based on the first aggregated incremental value ratio and the second aggregated incremental value ratio, ranking the first channel relative to the second channel.

19. The method of claim 11, further comprising:
associating a first plurality of content providers with a first keyword;
generating a first aggregated incremental value ratio for the first plurality of content providers;
associating a second plurality of content providers with a second keyword;
generating a second aggregated incremental value ratio for the second plurality of content providers;
based on the first aggregated incremental value ratio and the second aggregated incremental value ratio, ranking the first keyword relative to the second keyword.

20. A system comprising:
one or more processors;
one or more storage media storing instructions which, when executed by the one or more processors, cause:
identifying a plurality of content item selection events in which a content item of a first content provider was a candidate for selection;
for a first content item selection event of the plurality of content item selection events, determining a first amount that the first content provider contributed as a result of being selected for the first content item selection event;
simulating the first content item selection event by determining a second amount that a second content provider would have contributed as a result of the first content item selection event if the second content provider was selected for the first content item selection event instead of the first content provider;
simulating a second content item selection event of the plurality of content item selection events by determining a difference between (1) a third amount that a third content provider contributed as a result of being selected for the second content item selection event and (2) a fourth amount that the third content provider would have contributed if the first content provider was not a candidate for selection in the second content item selection event;
based on the first amount, the second amount, and the third amount, calculating an incremental value ratio for the first content provider;
based on the incremental value ratio, causing data about the first content item provider to be displayed on a screen of a computing device.
